(19) United States
(12) Patent Application Publication
(10) Pub. No.: US 2026/0147591 A1
(43) Pub. Date: May 28, 2026

(54) VIDEO EDITING METHOD AND DEVICE, AND STORAGE MEDIUM

(71) Applicant: Beijing Zitiao Network Technology Co., Ltd., Haidian District (CN)

(72) Inventors: Mengliang CHEN, Beijing (CN); Enbao LIU, Beijing (CN); Mingjun ZHENG, Beijing (CN); Liang LIANG, Beijing (CN); Chenyu XIANG, Beijing (CN)

(21) Appl. No.: 19/364,062

(22) Filed: Oct. 21, 2025

(30) Foreign Application Priority Data
Nov. 27, 2024 (CN) 202411723681.4

(51) Int. Cl. G06F 9/451; G06F 3/0484; G11B 27/031

(52) U.S. Cl. CPC G06F 9/451; G06F 3/0484; G11B 27/031

(57) ABSTRACT

The present disclosure provide a video editing method and device, and a storage medium. The video editing method includes: in response to a trigger instruction for a target editor, determining an interface interaction component of the target editor, and displaying an editing interface of the target editor based on the interface interaction component; in response to a trigger operation for a target editing function on the target editor, invoking the functional component of the target editing function through the interface interaction component, and displaying an interactive control for the target editing function on the editing interface of the target editor through the functional component of the target editing function; and in response to an interactive operation for the interactive control for the target editing function, applying the target editing function to a material in a video editing draft, and displaying a video editing effect.

### CROSS-REFERENCE TO RELATED APPLICATIONS

The present application is based on and claims priority to China Patent Application No. 202411723681.4 filed on Nov. 27, 2024, the disclosure of which is incorporated by reference herein in its entirety.

### TECHNICAL FIELD

Embodiments of the present disclosure relate to a video editing method and device, and a storage medium.

### BACKGROUND

With the development of video editing technologies, different forms of video editors continuously emerge and are applied for different purposes or usage scenarios, such as template-based editors, multi-track editors, script-based editors, and dialog editors. In some video editing tools, a variety of different video editors are provided at the same time.

In the related art, different forms of video editors are typically developed independently, but the same editing functional component may exist in the different forms of video editors. The editing functional components are coupled within the video editors and generally cannot be reused, resulting in the need for repeated development of the same editing functional components across the different forms of video editors, which increases costs and reduces development efficiency.

### SUMMARY

In a first aspect, an embodiment of the present disclosure provides a video editing method, including: determining, in response to a trigger instruction for a target editor, an interface interaction component of the target editor and displaying an editing interface of the target editor based on the interface interaction component, where the interface interaction component is configured to indicate an interaction manner for a user to use at least one editing function on a video editing interface, and the interface interaction component is configured to invoke a functional component of the at least one editing function; invoking, in response to a trigger operation for a target editing function on the target editor, a functional component of the target editing function through the interface interaction component, and displaying an interactive control for the target editing function on the editing interface of the target editor through the functional component of the target editing function, where the at least one editing function includes the target editing function; and applying, in response to an interactive operation for the interactive control for the target editing function, the target editing function to a material in a video editing draft based on the interactive operation, and displaying a video editing effect.

In a second aspect, an embodiment of the present disclosure provides a video editing device, including: a startup unit configured to determine, in response to a trigger instruction for a target editor, an interface interaction component of the target editor and display an editing interface of the target editor based on the interface interaction component, where the interface interaction component is configured to indicate an interaction manner for a user to use at least one editing function on the video editing interface, and the interface interaction component is configured to invoke a functional component of the at least one editing function; an invoking unit configured to invoke, in response to a trigger operation for a target editing function on the target editor, a functional component of the target editing function through the interface interaction component and display an interactive control for the target editing function on the editing interface of the target editor through the functional component of the target editing function, where the at least one editing function includes the target editing function; and an execution unit configured to apply, in response to an interactive operation for the interactive control for the target editing function, the target editing function to a material in a video editing draft based on the interactive operation and display a video editing effect.

In a third aspect, an embodiment of the present disclosure provides an electronic device, including: at least one processor and a memory, where the memory stores computer-executable instructions; and the at least one processor executes the computer-executable instructions stored in the memory, to cause the at least one processor to perform the video editing method according to the first aspect and various possible designs of the first aspect.

In a fourth aspect, an embodiment of the present disclosure provides a computer-readable storage medium. The computer-readable storage medium stores computer-executable instructions that, when executed by a processor, cause the video editing method according to the first aspect and various possible designs of the first aspect to be implemented.

In a fifth aspect, an embodiment of the present disclosure provides a computer program product, including computer-executable instructions that, when executed by a processor, cause the video editing method according to the first aspect and various possible designs of the first aspect to be implemented.

### BRIEF DESCRIPTION OF THE DRAWINGS

In order to describe the technical solutions in embodiments of the present disclosure or in the prior art more clearly, the accompanying drawings for describing the embodiments or the prior art are briefly described below. Apparently, the accompanying drawings in the following description are some embodiments of the present disclosure, and those of ordinary skill in the art may still derive other accompanying drawings from these accompanying drawings without creative efforts.

FIG. 1 is a schematic diagram of an application scenario of a video editing method according to an embodiment of the present disclosure;

FIG. 2 is a schematic flowchart of a video editing method according to an embodiment of the present disclosure;

FIG. 3 is an architectural diagram of a video editing tool according to an embodiment of the present disclosure;

FIG. 4 is a schematic flowchart of a video editing method according to another embodiment of the present disclosure;

FIG. 5 is a block diagram of a structure of a video editing device according to an embodiment of the present disclosure; and

FIG. 6 is a schematic diagram of a hardware structure of an electronic device according to an embodiment of the present disclosure.

### DETAILED DESCRIPTION

In order to make the objectives, technical solutions, and advantages of embodiments of the present disclosure clearer, the technical solutions in the embodiments of the present disclosure are described clearly and completely below with reference to the accompanying drawings in the embodiments of the present disclosure. Apparently, the embodiments described are some rather than all of the embodiments of the present disclosure. All other embodiments obtained by those of ordinary skill in the art based on the embodiments of the present disclosure without any creative effort shall fall within the scope of protection of the present disclosure.

In the related art, different forms of video editors are usually developed independently, that is, code of the different forms of video editors is independent of each other, but the same editing functional component may exist in the different forms of video editors. For example, a filter component, a beauty retouch component, a sound effect component, a sticker component, and the like may exist in both a template-based editor and a multi-track editor. However, in different video editors, the editing functional components are coupled with the video editors, and usually cannot be reused across different editors, resulting in the need for repeated development of the same editing functional component in the different forms of video editors, which increases costs and reduces development efficiency.

In view of this, embodiments of the present disclosure provide a video editing method and device, and a storage medium, to implement reuse of an editing functional component by different editors, thereby reducing development costs and improving development efficiency.

An embodiment of the present disclosure provides a video editing method. In response to a trigger instruction for a target editor, an interface interaction component of the target editor is determined, and an editing interface of the target editor is displayed based on the interface interaction component, where the interface interaction component is configured to indicate an interaction manner for a user to use at least one editing function on the video editing interface, and the interface interaction component is configured to invoke a functional component of the at least one editing function; in response to the trigger operation on the target editing function on the target editor, the functional component of the target editing function is invoked through the interface interaction component, and the interactive control for the target editing function is displayed on the editing interface of the target editor through the functional component of the target editing function, where the at least one editing function includes the target editing function; and in response to an interactive operation on the interactive control for the target editing function, the target editing function is applied to a material in a video editing draft based on the interactive operation, and a video editing effect is displayed. In this embodiment, the editing functions are split and decoupled into editing function modules in advance, and the functional module of the target editing function may be invoked when the target editing function needs to be used in the target editor, which implements quick reuse of the editing function, avoiding the need for repeated development of basic editing functions across a variety of editors, reducing development costs, and improving development efficiency.

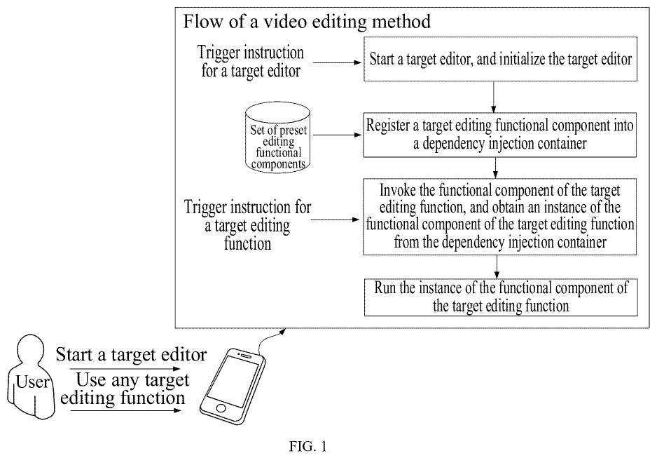

The video editing method provided by the embodiment of the present disclosure is applied in an application scenario as shown in FIG. 1, in which a video editing tool is installed in an electronic device, such as a terminal device or a server, that can be configured to perform video editing, the video editing tool provides different editors, and basic editing functions used in various editors are split into independent components in advance, to constitute a set of preset editing functional components. In a specific implementation, the user initializes the target editor upon starting the target editor, determines a target editing function required by a target editing region, and registers the functional component of the target editing function in the set of preset editing functional components into a dependency injection container. When the user uses any target editing function in the target editor, an invocation of the functional component of the target editing function is triggered, an instance of the functional component of the target editing function is obtained from the dependency injection container, and the instance of the functional component of the target editing function is run, to execute the target editing function on the material in the video editing draft and display the video editing effect.

The video editing method of the present disclosure is described in detail below with reference to specific embodiments.

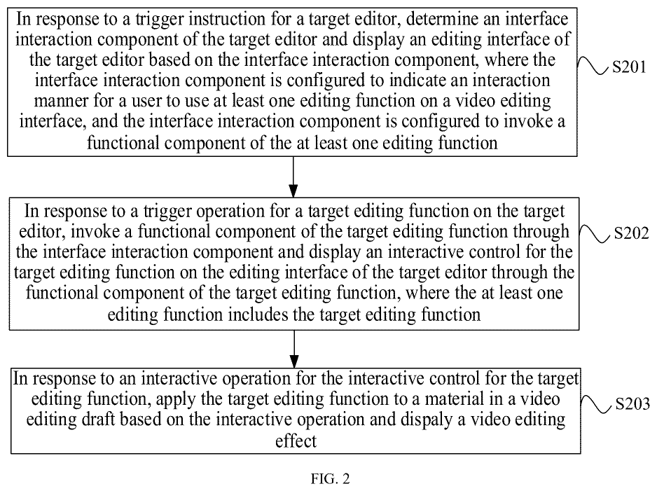

Referring to FIG. 2, FIG. 2 is a schematic flowchart of a video editing method according to an embodiment of the present disclosure. The method in this embodiment may be applied to an electronic device, such as a terminal device or a server, that can be used for video editing. The video editing method includes the following steps.

In step S201, in response to a trigger instruction for a target editor, an interface interaction component of the target editor is determined, and an editing interface of the target editor is displayed based on the interface interaction component, where the interface interaction component is configured to indicate an interaction manner for a user to use at least one editing function on the video editing interface, and the interface interaction component is configured to invoke a functional component of the at least one editing function.

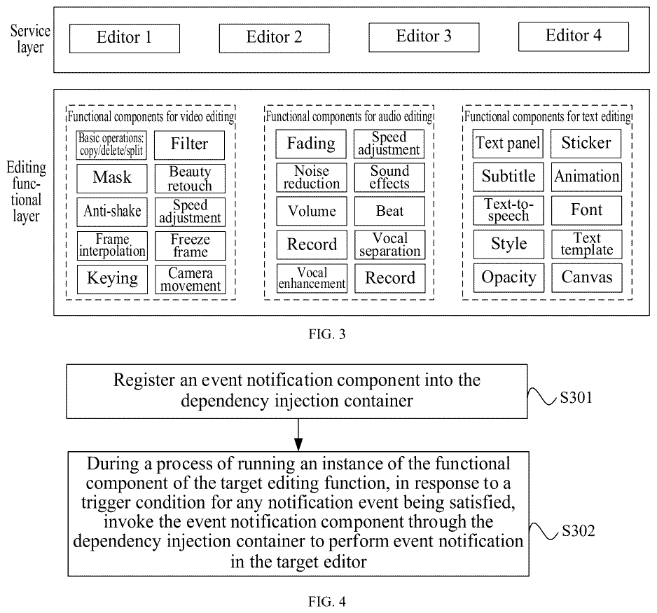

In this embodiment, a variety of editors may be provided in a video editing tool, where a variety of editors have different uses or application scenarios, such as template-based editors, multi-track editors, script-based editors, dialog editors, and the like. The different editors may have the same editing functions, and certainly may alternatively have different editing functions. In this embodiment, the basic editing functions used in various editors are split into independent components in advance to constitute a set of preset editing functional components, where optionally, the split functional components of the editing function may be fine-grained functional components for atomic operations. Specifically, as shown in FIG. 3, the video editing tool provides a service layer and an editing functional layer, where the service layer provides a variety of editors, and the editing functional layer provides functional components of various editing functions of the set of preset editing functional components.

In some embodiments, a principle of splitting the editing functional components may include a common reuse principle and a common closure principle, where the common reuse principle is that code in a component is reused for the same reason, that is, when splitting the editing functional components, code of functions that are usually reused is placed in one component; and the common closure principle is that code in components is modified for the same reason, that is, when splitting the editing functional components, code of functions that is usually modified at the same time and is modified for the same reason is placed in one component. For example, the set of preset editing functional components may include functional components for video editing, such as a filter component, a mask component, a beauty retouch component, an anti-shake component, a basic operation (such as copy, delete, split, etc.) component, and the like, may further include functional components for audio editing, such as a fading component, a speed adjustment component, a noise reduction component, a sound effect component, and the like, and may further include functional components for text editing, such as a text panel component, a sticker component, a subtitle component, an animation component, a text-to-speech component, and the like. This embodiment is certainly not limited to the editing functional components listed above, and may further include other editing functional components.

Further, in this embodiment, an interface interaction component may be provided for each editor. After the editor is triggered, the editing interface of the editor may be displayed based on the interface interaction component. The editing interface may include at least one editing function. The interface interaction component may be configured to indicate an interaction manner for a user to use at least one editing function on the video editing interface, and may invoke the functional component of at least one editing function when the user triggers the at least one editing function.

In a particular implementation, when the user triggers the target editor, in response to the trigger instruction for the target editor, the interface interaction component of the target editor may be determined, and the editing interface of the target editor may be displayed based on the interface interaction component.

In step S202, in response to a trigger operation for a target editing function on the target editor, a functional component of the target editing function is invoked through the interface interaction component and an interactive control for the target editing function is displayed on the editing interface of the target editor through the functional component of the target editing function. The at least one editing function includes the target editing function.

In this embodiment, when the user needs to use the target editing function on the target editor, the trigger operation may be performed on the target editing function on the target editor, the functional component of the target editing function may then be invoked through the interface interaction component based on the trigger operation, and the interactive control for the target editing function is displayed on the editing interface of the target editor through the functional component of the target editing function, where the interactive control for the target editing function is an interactive control configured for interactive operations, such as configuration, adjustment, and the like, of parameters of the target editing function, which are required to be performed during the process of using the target editing function by the user.

In step S203, in response to an interactive operation for the interactive control for the target editing function, the target editing function is applied to a material in a video editing draft based on the interactive operation and a video editing effect is displayed.

In this embodiment, after the interactive control for the target editing function is displayed on the editing interface of the target editor, the user may use the target editing function through the interactive control for the target editing function, and may perform the interactive operation for the interactive control. Then, the target editing function is applied to the material in the video editing draft based on the interactive operation, such as adding a filter, beauty retouch, or anti-shake, and the video editing effect is displayed.

According to the video editing method provided in this embodiment, in response to the trigger instruction for the target editor, the interface interaction component of the target editor is determined, and the editing interface of the target editor is displayed based on the interface interaction component, where the interface interaction component is configured to indicate the interaction manner for the user to use at least one editing function on the video editing interface, and the interface interaction component is configured to invoke the functional component of the at least one editing function; in response to the trigger operation for the target editing function on the target editor, the functional component of the target editing function is invoked through the interface interaction component, and the interactive control for the target editing function is displayed on the editing interface of the target editor through the functional component of the target editing function, where the at least one editing function includes the target editing function; and in response to the interactive operation for the interactive control for the target editing function, the target editing function is applied to the material in the video editing draft based on the interactive operation and the video editing effect is displayed. In this embodiment, the editing functions are split and decoupled into editing function modules in advance, and the functional module of the target editing function may be invoked when the target editing function needs to be used in the target editor, which implements quick reuse of the editing function, avoiding the need for repeated development of basic editing functions across a variety of editors, reducing development costs, and improving development efficiency.

On the basis of any one of the above-mentioned embodiments, invoking the functional component of the target editing function through the interface interaction component, and displaying the interactive control for the target editing function on the editing interface of the target editor through the functional component of the target editing function in S202 may specifically include: invoking the functional component of the target editing function through the interface interaction component, registering the functional component of the target editing function into a dependency injection container, and displaying the interactive control for the target editing function on the editing interface of the target editor.

In this embodiment, dependency injection (DI) is used to manage a dependency relationship of the functional components of the target editing function needing to be used in the target editor. The dependency relationship between the functional components of the target editing function is managed by the dependency injection container, rather than directly creating dependent objects inside an object, which reduces the coupling between code, and improves testability, reusability and maintainability of the code. Through dependency injection, the dependency relationship may be more flexibly managed and configured, so that a program is easier to expand and maintain. After the functional component of the target editing function is registered into the dependency injection container, the interactive control for the target editing function is displayed on the editing interface of the target editor.

In some embodiments, a process of registering the functional component of the target editing function into the dependency injection container may alternatively be performed in advance, that is, when the target editor is started and initialized, the user may know which editing functions are included in the target editor, how to use the target editor, and the like, and then functional components of these editing functions are registered into the dependency injection container.

In some embodiments, since the editing functions are split into fine-grained atomic operations in the set of preset editing functional components, functional components of some editing functions may depend on functional components of other editing functions, for example, the sticker component may depend on the text panel component, or the text-to-speech component may depend on the sound effects component, that is, there are dependency relationships. When implementing editing function A, it is necessary to execute editing function B, so there is a dependency relationship between an editing function A component and an editing function B component. If it is determined that there is a dependency relationship between a functional component of any target editing function and a functional component of an other editing function, the functional component of the other editing function that has the dependency relationship with the functional component of the target editing function is also registered into the dependency injection container, to be convenient for a subsequent invocation to the functional component of the target editing function.

The dependency relationships in the above-mentioned embodiments may satisfy the following dependency principles: a stable dependency principle and an acyclic dependency principle, where the stable dependency principle is that the dependency relationship is from the top down and avoids horizontal dependency, and the acyclic dependency principle is that there should be no dependency loop (circular dependency) among the components.

On the basis of any one of the above-mentioned embodiments, applying, in response to the interactive operation for the interactive control for the target editing function, the target editing function to the material in the video editing draft based on the interactive operation and displaying the video editing effect in S203 may specifically include: in response to the interactive operation for the interactive control for the target editing function, obtaining an instance of the functional component of the target editing function from the dependency injection container, and for the material in the video editing draft, running the instance of the functional component of the target editing function to apply the target editing function to the material in the video editing draft and display the video editing effect.

In this embodiment, when the user uses the target editing function, the instance of the functional component of the target editing function may be obtained from the dependency injection container, where the instance of the functional component of the target editing function provides access to internal states and functions of the functional component of the target editing function, and instantiation of the functional component of the target editing function may be instantiation performed by the dependency injection container when the functional component of the target editing function is invoked, which may avoid that instantiation of the functional component of the target editing function that is not invoked occupies a large amount of computing resources and storage resources. Certainly, instantiation may alternatively be performed at any time before the invocation.

After the instance of the functional component of the target editing function is obtained, the instance may be run, thereby applying the target editing function to the material in the video editing draft. A specific implementation process of the running instance is not limited here.

In some embodiments, during a process of running the instance of the functional component of the target editing function, in response to determining that the functional component of the target editing function has the dependency relationship with the functional component of the other editing function, an instance of the functional component of the other editing function is obtained from the dependency injection container, and the instance of the functional component of the other editing function is run.

In this embodiment, since the functional component of the target editing function may have the dependency relationship with the functional component of the other editing function, during the process of running the instance of the functional component of the target editing function, in response to determining that the functional component of the target editing function has the dependency relationship with the functional component of the other editing function, the instance of the functional component of the other editing function that has the dependency relationship with the functional component of the target editing function is obtained from the dependency injection container, and the instance of the functional component of the other editing function is run. However, the timing of running needs to be determined during the process of running the instance of the functional component of the target editing function, that is, the instance of the functional component of the other editing function is run when the functional component of the other editing function needs to be invoked. The functional component of the target editing function may depend on functional components of one or more other editing functions, and then it is necessary to run instances of the functional components of the one or more other editing functions during the process of running the functional component of the target editing function. In addition, the functional components of the one or more other editing functions may further have dependent editing functional components of the next level, and so on, and based on a dependency relationship logic, instances of next-level editing functional components may be obtained and run level by level.

In a specific embodiment, if a certain editing functional component needs to depend on a functional component of an other editing function, one or more interfaces for invoking the other editing functions may be pre-configured in the editing functional component. That is, the interface indicates that the editing functional component has a dependency relationship with the functional component of the other editing function, and then whether the functional component of the target editing function is pre-configured with the interface for invoking the functional component of the other editing function may be determined while determining that whether any target editing function module has the dependency relationship with the other editing function module. If it is determined that the functional component of the target editing function is pre-configured with the interface for invoking the functional component of the other editing function, it is determined that the functional component of the target editing function needs to depend on the functional component of the other editing function, and then, the functional component of the other editing function that has the dependency relationship may be registered into the dependency injection container through the above-mentioned determination process during a target editor initialization stage. In addition, an instance of the functional component of the other editing function that has the dependency relationship may be obtained and run from the dependency injection container through the above-mentioned determination process, when the instance of the functional component of the target editing function is run.

Considering that there may be a functional difference (a non-parametric difference) in different editors for functional components with the same editing function, for example in editor 1, a functional component of editing function A depends on a functional component of editing function B, while in editor 2, a functional component of editing function A depends on a functional component of editing function C. Dependency relationships of the different functional components may be pre-configured in first preset configuration information of the different editors. In some embodiments, the first preset configuration information may be a specific protocol or code, including a target invocation logic for the functional component of any target editing function to the functional component of the other editing function in the target editor, that is, different dependency relationships of the same editing functional component are pre-configured in the different editors through the protocol or code, thereby implementing differentiated processing logics of the same editing functional component in the different editors. For example, a sticker component has different representations in a template-based editor and a multi-track editor. In the template-based editor, the sticker component is to replace an old sticker in a template with a new sticker, and in the multi-track editor, the sticker component is to add a new sticker in a track. To implement the above-mentioned difference, the sticker component needs to depend on different functional components of other editing functions, protocols of the template-based editor and the multi-track editor for the sticker component may be respectively configured, and a representation difference of the sticker component is configured in the protocols; particularly, dependency relationships with the different functional components of the other editing functions are configured, that is, invoking interfaces for the different functional components of the other editing functions are configured.

Further, during an initialization process of the target editor, in response to determining that the functional component of any target editing function is pre-configured with a plurality of interfaces for invoking functional components of other editing functions, a target interface matching first preset configuration information is selected, according to the first preset configuration information of the target editor, from the plurality of interfaces for invoking the functional components of the other editing functions, where the target interface is an interface that is pre-configured in the first preset configuration information of the target editor, and that corresponds to the functional component of the other editing function that the functional component of the target editing function needs to depend on, and then the functional component of the other editing function corresponding to the target interface is registered into the dependency injection container. For example, functional component A of the target editing function is pre-configured with interface b for invoking functional component B of other editing function, and interface c for invoking functional component C of the other editing function; however, functional component A of the target editing function only needing to depend on functional component C of the other editing function is pre-configured in first preset configuration information of target editor 1, then the target interface is interface c, and functional component C of the other editing function corresponding to interface c needs to be registered into the dependency injection container.

On the basis of any one of the above-mentioned embodiments, when obtaining the instance of the functional component of any target editing function from the dependency injection container, since the functional components of the same target editing function in different target editors may use different algorithms, and the functional components of the same target editing function may be provided by different suppliers (for example, with different code), instances of the functional components of the same target editing function may be different. For example, in editor 1, an instance of a functional component of editing function A to be run is instance S1, and in editor 2, an instance of a functional component of editing function A to be run is instance S2, which may be pre-configured in second preset configuration information of the editors, where the second preset information may be a specific protocol or code, or the second preset information may be configured in the above-mentioned first preset information, and the dependency injection container may obtain different instances of the functional component according to the second preset information.

Further, when obtaining the instance of the functional component of any target editing function from the dependency injection container, a target instance of the functional component of the target editing function may be obtained from the dependency injection container according to the second preset configuration information of the target editor, where the target instance is an instance matching the second preset configuration information among a plurality of instances of the functional component of the target editing function.

On the basis of any one of the above-mentioned embodiments, as shown in FIG. 4, the video editing method may further include the following steps.

In step S301, an event notification component is registered into the dependency injection container.

In step S302, During a process of running an instance of the functional component of the target editing function, in response to a trigger condition for any notification event being satisfied, the event notification component is invoked through the dependency injection container to perform event notification in the target editor.

In this embodiment, during a process that a user uses the functional component of the target editing function of the target editor, some event notifications may need to be displayed, such as successful or failed execution of the target editing function, an execution progress, and an operation prompt. To implement the above-mentioned purpose, an event notification function may be provided in this embodiment. Specifically, the event notification component may be registered into the dependency injection container, and trigger conditions corresponding to different event notifications are pre-configured, so that during the process of running an instance of the functional component of any target editing function, in response to the trigger condition of any notification event being satisfied, the event notification component is invoked through the dependency injection container to perform event notification in the target editor.

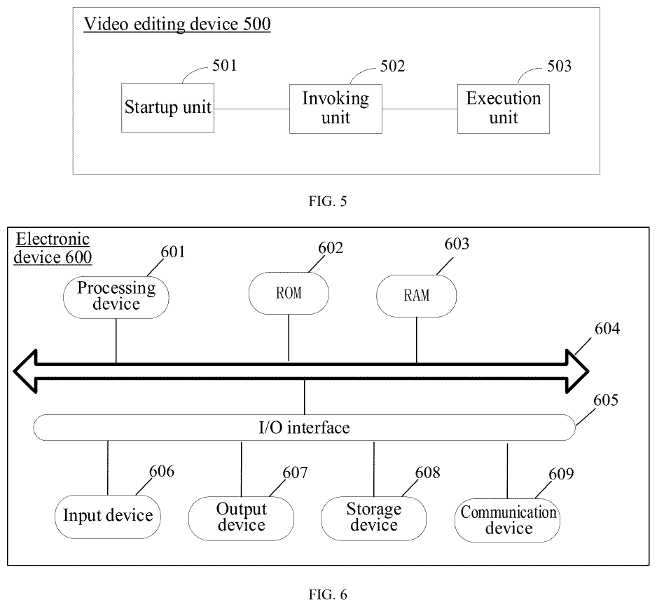

Corresponding to the video editing method in the above-mentioned embodiment, FIG. 5 is a block diagram of a structure of a video editing device according to an embodiment of the present disclosure. For ease of illustration, only parts related to this embodiment of the present disclosure are shown. Referring to FIG. 5, the video editing device 500 includes: a startup unit 501, an invoking unit 502, and an execution unit 503.

The startup unit 501 is configured to determine, in response to a trigger instruction for a target editor, an interface interaction component of the target editor, and display an editing interface of the target editor based on the interface interaction component, where the interface interaction component is configured to indicate an interaction manner for a user to use at least one editing function on a video editing interface, and the interface interaction component is configured to invoke a functional component of the at least one editing function.

The invoking unit 502 is configured to invoke, in response to a trigger operation for a target editing function on the target editor, a functional component of the target editing function through the interface interaction component and display an interactive control for the target editing function on the editing interface of the target editor through the functional component of the target editing function, where the at least one editing function includes the target editing function.

The execution unit 503 is configured to apply, in response to an interactive operation for the interactive control for the target editing function, the target editing function to a material in a video editing draft based on the interactive operation and display a video editing effect.

In one or more embodiments of the present disclosure, when invoking the functional component of the target editing function through the interface interaction component and displaying the interactive control for the target editing function on the editing interface of the target editor through the functional component of the target editing function, the invoking unit 502 is configured to: invoke the functional component of the target editing function through the interface interaction component, register the functional component of the target editing function into a dependency injection container, and display the interactive control for the target editing function on the editing interface of the target editor.

In one or more embodiments of the present disclosure, when applying, in response to the interactive operation for the interactive control for the target editing function, the target editing function to the material in the video editing draft based on the interactive operation and displaying the video editing effect, the execution unit 503 is configured to: obtain, in response to the interactive operation for the interactive control for the target editing function, an instance of the functional component of the target editing function from the dependency injection container, and for the material in the video editing draft, run the instance of the functional component of the target editing function, to apply the target editing function to the material in the video editing draft and display the video editing effect.

In one or more embodiments of the present disclosure, when registering the functional component of the target editing function into the dependency injection container, the invoking unit 502 is further configured to: register, in response to that the functional component of the target editing function has a dependency relationship with the functional component of an other editing function, the functional component of the other editing function into the dependency injection container.

In one or more embodiments of the present disclosure, when running the instance of the functional component of the target editing function, the execution unit 503 is further configured to: obtain, during a process of running the instance of the functional component of the target editing function, in response to determining that the functional component of the target editing function has the dependency relationship with the functional component of the other editing function, an instance of the functional component of the other editing function from the dependency injection container, and run the instance of the functional component of the other editing function.

In one or more embodiments of the present disclosure, when registering, in response to that the functional component of the target editing function has the dependency relationship with the functional component of the other editing function, the functional component of the other editing function into the dependency injection container, the invoking unit 502 is configured to: register, in response to that the functional component of the target editing function is pre-configured with an interface for invoking the functional component of the other editing function, the functional component of the other editing function into the dependency injection container.

In one or more embodiments of the present disclosure, when registering, in response to that the functional component of the target editing function is pre-configured with the interface for invoking the functional component of the other editing function, the functional component of the other editing function into the dependency injection container, the invoking unit 502 is configured to: select, in response to that the functional component of the target editing function is pre-configured with a plurality of interfaces for invoking functional components of other editing functions, according to first preset configuration information of the target editor, a target interface matching the first preset configuration information from the plurality of interfaces for invoking the functional components of the other editing functions, and register the functional component of the other editing function corresponding to the target interface into the dependency injection container.

In one or more embodiments of the present disclosure, the first preset configuration information includes: a target invocation logic of the functional component of the target editing function for the functional component of the other editing function in the target editor.

In one or more embodiments of the present disclosure, when obtaining the instance of the functional component of the target editing function from the dependency injection container, the execution unit 503 is configured to: obtain a target instance of the functional component of the target editing function from the dependency injection container according to second preset configuration information of the target editor, where the target instance is an instance matching the second preset configuration information among a plurality of instances of the functional component of the target editing function.

In one or more embodiments of the present disclosure, the second preset configuration information includes: an algorithm and/or supplier information required to be used by the functional component of the target editing function in the target editor.

In one or more embodiments of the present disclosure, the invoking unit 502 is further configured to register an event notification component into the dependency injection container.

The execution unit 503 is further configured to invoke, during the process of running an instance of the functional component of the target editing function, in response to a trigger condition for any notification event being satisfied, the event notification component through the dependency injection container to perform event notification in the target editor.

The device provided in this embodiment may be configured to perform the technical solution of the above-mentioned method embodiment. The implementation principle and technical effects thereof are similar, and are not described herein again in this embodiment.

Referring to FIG. 6, FIG. 6 is a schematic diagram of a structure of an electronic device 600 suitable for implementing the embodiments of the present disclosure. The electronic device 600 may be a terminal device or a server. The terminal device may include, but is not limited to, a mobile terminal such as a mobile phone, a notebook computer, a digital broadcast receiver, a personal digital assistant (PDA), a tablet computer (portable Android device, PAD), a portable media player (PMP), and a vehicle-mounted terminal (such as a vehicle navigation terminal), and a fixed terminal such as a digital TV and a desktop computer. The electronic device shown in FIG. 6 is merely an example, and shall not impose any limitation on the function and scope of use of the embodiments of the present disclosure.

As shown in FIG. 6, the electronic device 600 may include a processing device (for example, a central processing unit or a graphics processing unit) 601 that may perform a variety of appropriate actions and processing based on a program stored in a read-only memory (ROM) 602 or a program loaded from a storage device 608 into a random access memory (RAM) 603. The RAM 603 further stores various programs and data required for the operation of the electronic device 600. The processing device 601, the ROM 602, and the RAM 603 are connected to each other through a bus 604. An input/output (I/O) interface 605 is also connected to the bus 604.

Generally, the following devices may be connected to the I/O interface 605: an input device 606 including, for example, a touchscreen, a touchpad, a keyboard, a mouse, a camera, a microphone, an accelerometer, and a gyroscope; an output device 607 including, for example, a liquid crystal display (LCD), a speaker, and a vibrator; the storage device 608 including, for example, a tape and a hard disk; and a communication device 609. The communication device 609 may allow the electronic device 600 to perform wireless or wired communication with other devices to exchange data. Although FIG. 6 shows the electronic device 600 having various device, it should be understood that it is not required to implement or have all of the shown devices. It may be an alternative to implement or have more or fewer devices.

In particular, according to the embodiments of the present disclosure, the process described above with reference to the flowchart may be implemented as a computer software program. For example, an embodiment of the present disclosure includes a computer program product, which includes a computer program carried on a computer-readable medium, where the computer program includes program code for performing the method shown in the flowchart. In such an embodiment, the computer program may be downloaded from a network through the communication device 609 and installed, installed from the storage device 608, or installed from the ROM 602. When the computer program is executed by the processing device 601, the above-described functions defined in the method of the embodiment of the present disclosure are performed.

It should be noted that the above-mentioned computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. More specific examples of the computer-readable storage medium may include, but are not limited to: an electrical connection having one or more wires, a portable computer magnetic disk, a hard disk, a random access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may further be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), and the like, or any suitable combination thereof.

The above-mentioned computer-readable medium may be included in the above-mentioned electronic device. Alternatively, the computer-readable medium may exist independently, without being assembled into the electronic device.

The above-mentioned computer-readable medium carries one or more programs that, when executed by the electronic device, cause the electronic device to perform the method shown in the above-mentioned embodiment.

The computer program code for performing the operations in the present disclosure may be written in one or more programming languages or a combination thereof, where the programming languages include an object-oriented programming language, such as Java, Smalltalk, or C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user via any kind of network, including a local area network (LAN) or a wide area network (WAN), or may be connected to an external computer (for example, connected via the Internet with the aid of an Internet service provider).

The flowchart and block diagram in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. Names of the units do not constitute a limitation on the units themselves in some cases, for example, a first obtaining unit may alternatively be described as “a unit for obtaining at least two Internet protocol addresses”.

The functions described herein above may be performed at least partially by one or more hardware logic components. For example, without limitation, example types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

In a first aspect, according to one or more embodiments of the present disclosure, a video editing method is provided. The video editing method includes: in response to a trigger instruction for a target editor, determining an interface interaction component of the target editor, and displaying an editing interface of the target editor based on the interface interaction component, where the interface interaction component is configured to indicate an interaction manner for a user to use at least one editing function on the video editing interface, and the interface interaction component is configured to invoke a functional component of the at least one editing function; in response to a trigger operation for a target editing function on the target editor, invoking a functional component of the target editing function through the interface interaction component, and displaying an interactive control for the target editing function on the editing interface of the target editor through the functional component of the target editing function, where the at least one editing function includes the target editing function; and in response to an interactive operation for the interactive control for the target editing function, applying the target editing function to a material in a video editing draft based on the interactive operation and displaying a video editing effect.

According to one or more embodiments of the present disclosure, invoking the functional component of the target editing function through the interface interaction component, and displaying the interactive control for the target editing function on the editing interface of the target editor through the functional component of the target editing function includes: invoking the functional component of the target editing function through the interface interaction component, registering the functional component of the target editing function into a dependency injection container, and displaying the interactive control for the target editing function on the editing interface of the target editor.

According to one or more embodiments of the present disclosure, in response to the interactive operation for the interactive control for the target editing function, applying the target editing function to the material in the video editing draft based on the interactive operation, and displaying the video editing effect includes: in response to the interactive operation for the interactive control for the target editing function, obtaining an instance of the functional component of the target editing function from the dependency injection container, and for the material in the video editing draft, running the instance of the functional component of the target editing function, to apply the target editing function to the material in the video editing draft and display the video editing effect.

According to one or more embodiments of the present disclosure, registering the functional component of the target editing function into the dependency injection container further includes: registering, in response to that the functional component of the target editing function has a dependency relationship with functional component of an other editing function, the functional component of the other editing function into the dependency injection container.

According to one or more embodiments of the present disclosure, running the instance of the functional component of the target editing function further includes: during a process of running the instance of the functional component of the target editing function, in response to determining that the functional component of the target editing function has the dependency relationship with the functional component of the other editing function, obtaining an instance of the functional component of the other editing function from the dependency injection container, and running the instance of the functional component of the other editing function.

According to one or more embodiments of the present disclosure, registering, in response to that the functional component of the target editing function has the dependency relationship with the functional component of the other editing function, the functional component of the other editing function into the dependency injection container includes: registering, in response to that the functional component of the target editing function is pre-configured with an interface for invoking the functional component of the other editing function, the functional component of the other editing function into the dependency injection container.

According to one or more embodiments of the present disclosure, registering, in response to that the functional component of the target editing function is pre-configured with the interface for invoking the functional component of the other editing function, the functional component of the other editing function into the dependency injection container includes: in response to that the functional component of the target editing function is pre-configured with a plurality of interfaces for invoking functional components of other editing functions, selecting, according to first preset configuration information of the target editor, a target interface matching the first preset configuration information from the plurality of interfaces for invoking the functional components of the other editing functions, and registering the functional component of the other editing function corresponding to the target interface into the dependency injection container.

According to one or more embodiments of the present disclosure, the first preset configuration information includes: a target invocation logic of the functional component of the target editing function for the functional component of the other editing function in the target editor.

According to one or more embodiments of the present disclosure, obtaining the instance of the functional component of the target editing function from the dependency injection container includes: obtaining a target instance of the functional component of the target editing function from the dependency injection container according to second preset configuration information of the target editor, where the target instance is an instance matching the second preset configuration information among a plurality of instances of the functional component of the target editing function.

According to one or more embodiments of the present disclosure, the second preset configuration information includes: an algorithm and/or supplier information required to be used by the functional component of the target editing function in the target editor.

According to one or more embodiments of the present disclosure, the method further includes: registering an event notification component into the dependency injection container; and during a process of running an instance of the functional component of the target editing function, in response to a trigger condition for any notification event being satisfied, invoking the event notification component through the dependency injection container to perform event notification in the target editor.

In a second aspect, according to one or more embodiments of the present disclosure, a video editing device is provided. The video editing device includes: a startup unit configured to, in response to a trigger instruction for a target editor, determine an interface interaction component of the target editor, and display an editing interface of the target editor based on the interface interaction component, where the interface interaction component is configured to indicate an interaction manner for a user to use at least one editing function on a video editing interface, and the interface interaction component is configured to invoke a functional component of the at least one editing function; an invoking unit configured to, in response to a trigger operation for a target editing function on the target editor, invoke the functional component of the target editing function through the interface interaction component, and display an interactive control for the target editing function on the editing interface of the target editor through the functional component of the target editing function, where the at least one editing function includes the target editing function; and an execution unit configured to, in response to an interactive operation for the interactive control for the target editing function, apply the target editing function to a material in a video editing draft based on the interactive operation, and display a video editing effect.

According to one or more embodiments of the present disclosure, when invoking the functional component of the target editing function through the interface interaction component and displaying the interactive control for the target editing function on the editing interface of the target editor through the functional component of the target editing function, the invoking unit is configured to: invoke the functional component of the target editing function through the interface interaction component, register the functional component of the target editing function into a dependency injection container, and display the interactive control for the target editing function on the editing interface of the target editor.

According to one or more embodiments of the present disclosure, when, in response to the interactive operation for the interactive control for the target editing function, applying the target editing function to the material in the video editing draft based on the interactive operation, and displaying the video editing effect, the execution unit is configured to: in response to the interactive operation for the interactive control for the target editing function, obtain an instance of the functional component of the target editing function from the dependency injection container, and for the material in the video editing draft, run the instance of the functional component of the target editing function to apply the target editing function to the material in the video editing draft and display the video editing effect.

According to one or more embodiments of the present disclosure, when registering the functional component of the target editing function into the dependency injection container, the invoking unit is further configured to: in response to that the functional component of the target editing function has a dependency relationship with functional component of an other editing function, register the functional component of the other editing function into the dependency injection container.

According to one or more embodiments of the present disclosure, when running the instance of the functional component of the target editing function, the execution unit is further configured to: during a process of running the instance of the functional component of the target editing function, in response to determining that the functional component of the target editing function has the dependency relationship with the functional component of an other editing function, obtain an instance of the functional component of the other editing function from the dependency injection container, and run the instance of the functional component of the other editing function.

According to one or more embodiments of the present disclosure, when registering, in response to that the functional component of the target editing function has the dependency relationship with the functional component of the other editing function, the functional component of the other editing function into the dependency injection container the invoking unit is configured to: register, in response to that the functional component of the target editing function is pre-configured with an interface for invoking the functional component of the other editing function, the functional component of the other editing function into the dependency injection container.

According to one or more embodiments of the present disclosure, when registering, in response to that the functional component of the target editing function is pre-configured with the interface for invoking the functional component of the other editing function, the functional component of the other editing function into the dependency injection container, the invoking unit is configured to: in response to that the functional component of the target editing function is pre-configured with a plurality of interfaces for invoking functional components of other editing functions, select, according to first preset configuration information of the target editor, a target interface matching the first preset configuration information from the plurality of interfaces for invoking the functional components of the other editing functions, and register the functional component of the other editing function corresponding to the target interface into the dependency injection container.

According to one or more embodiments of the present disclosure, the first preset configuration information includes: a target invocation logic of the functional component of the target editing function for the functional component of the other editing function in the target editor.

According to one or more embodiments of the present disclosure, when obtaining the instance of the functional component of the target editing function from the dependency injection container, the execution unit is configured to: obtain a target instance of the functional component of the target editing function from the dependency injection container according to second preset configuration information of the target editor, where the target instance is an instance matching the second preset configuration information among a plurality of instances of the functional component of the target editing function.

According to one or more embodiments of the present disclosure, the second preset configuration information includes: an algorithm and/or supplier information required to be used by the functional component of the target editing function in the target editor.

According to one or more embodiments of the present disclosure, the invoking unit is further configured to register an event notification component into the dependency injection container; and the execution unit is further configured to, during the process of running an instance of the functional component of the target editing function, in response to a trigger condition for any notification event being satisfied, invoke the event notification component through the dependency injection container to perform event notification in the target editor.

In a third aspect, according to one or more embodiments of the present disclosure, an electronic device is provided. The electronic device includes: at least one processor and a memory, where the memory stores computer-executable instructions; and the at least one processor executes the computer-executable instructions stored in the memory, to cause the at least one processor to perform the video editing method according to the first aspect and various possible designs of the first aspect.

In a fourth aspect, according to one or more embodiments of the present disclosure, a computer-readable storage medium is provided. The computer-readable storage medium stores computer-executable instructions that, when executed by a processor, cause the video editing method according to the first aspect and various possible designs of the first aspect to be implemented.

In a fifth aspect, according to one or more embodiments of the present disclosure, a computer program product is provided. The computer program product includes computer-executable instructions that, when executed by a processor, cause the video editing method according to the first aspect and various possible designs of the first aspect to be implemented.

The above-mentioned descriptions are merely preferred embodiments of the present disclosure and explanations of the applied technical principles. Those skilled in the art should understand that the scope of disclosure involved in the present disclosure is not limited to the technical solutions formed by specific combinations of the above-mentioned technical features, and shall also cover other technical solutions formed by any combination of the above-mentioned technical features or equivalent features thereof without departing from the above-mentioned disclosed concept. For example, a technical solution formed by a replacement of the above-mentioned features with technical features with similar functions disclosed in the present disclosure (but not limited thereto) also falls within the scope of the present disclosure.

In addition, although the various operations are depicted in a specific order, it should not be construed as requiring these operations to be performed in the specific order shown or in a sequential order. Under certain circumstances, multitasking and parallel processing may be advantageous. Similarly, although several specific implementation details are included in the above-mentioned discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable sub-combination.

Although the subject matter has been described in a language specific to structural features and/or logical actions of the method, it should be understood that the subject matter defined in the appended claims is not necessarily limited to the specific features or actions described above. In contrast, the specific features and actions described above are merely example forms of implementing the claims.

What is claimed is:

1. A video editing method, comprising:
determining, in response to a trigger instruction for a target editor, an interface interaction component of the target editor and displaying an editing interface of the target editor based on the interface interaction component, wherein the interface interaction component is configured to indicate an interaction manner for a user to use at least one editing function on a video editing interface, and the interface interaction component is configured to invoke a functional component of the at least one editing function;
invoking, in response to a trigger operation for a target editing function on the target editor, the functional component of the target editing function through the interface interaction component and displaying an interactive control for the target editing function on the editing interface of the target editor through the functional component of the target editing function, wherein the at least one editing function comprises the target editing function; and
applying, in response to an interactive operation for the interactive control for the target editing function, the target editing function to a material in a video editing draft based on the interactive operation and displaying a video editing effect.

2. The video editing method according to claim 1, wherein invoking the functional component of the target editing function through the interface interaction component and displaying the interactive control for the target editing function on the editing interface of the target editor through the functional component of the target editing function comprises:
invoking the functional component of the target editing function through the interface interaction component, registering the functional component of the target editing function into a dependency injection container, and displaying the interactive control for the target editing function on the editing interface of the target editor.

3. The video editing method according to claim 2, wherein applying, in response to the interactive operation for the interactive control for the target editing function, the target editing function to the material in the video editing draft based on the interactive operation and displaying the video editing effect comprises:
obtaining, in response to the interactive operation for the interactive control for the target editing function, an instance of the functional component of the target editing function from the dependency injection container, and for the material in the video editing draft, running the instance of the functional component of the target editing function to apply the target editing function to the material in the video editing draft and display the video editing effect.

4. The video editing method according to claim 3, wherein registering the functional component of the target editing function into the dependency injection container comprises:
registering, in response to that the functional component of the target editing function has a dependency relationship with the functional component of an other editing function, the functional component of the other editing function into the dependency injection container.

5. The video editing method according to claim 4, wherein running the instance of the functional component of the target editing function comprises:
obtaining, during a process of running the instance of the functional component of the target editing function, in response to determining that the functional component of the target editing function has the dependency relationship with the functional component of the other editing function, an instance of the functional component of the other editing function from the dependency injection container, and running the instance of the functional component of the other editing function.

6. The video editing method according to claim 4, wherein registering, in response to that the functional component of the target editing function has the dependency relationship with the functional component of the other editing function, the functional component of the other editing function into the dependency injection container comprises:
registering, in response to that the functional component of the target editing function is pre-configured with an interface for invoking the functional component of the other editing function, the functional component of the other editing function into the dependency injection container.

7. The video editing method according to claim 6, wherein registering, in response to that the functional component of the target editing function is pre-configured with the interface for invoking the functional component of the other editing function, the functional component of the other editing function into the dependency injection container comprises:
selecting, in response to that the functional component of the target editing function is pre-configured with a plurality of interfaces for invoking functional components of other editing functions, according to first preset configuration information of the target editor, a target interface matching the first preset configuration information from the plurality of interfaces for invoking the functional components of the other editing functions, and registering the functional component of the other editing function corresponding to the target interface into the dependency injection container.

8. The video editing method according to claim 7, wherein the first preset configuration information comprises: a target invocation logic of the functional component of the target editing function for the functional component of the other editing function in the target editor.

9. The video editing method according to claim 3, wherein obtaining the instance of the functional component of the target editing function from the dependency injection container comprises:
obtaining a target instance of the functional component of the target editing function from the dependency injection container according to second preset configuration information of the target editor, wherein the target instance is an instance matching the second preset configuration information among a plurality of instances of the functional component of the target editing function.

10. The video editing method according to claim 9, wherein the second preset configuration information comprises: an algorithm and/or supplier information required to be used by the functional component of the target editing function in the target editor.

11. The video editing method according to claim 1, further comprising:
registering an event notification component into a dependency injection container; and
invoking, during a process of running an instance of the functional component of the target editing function, in response to a trigger condition for any notification event being satisfied, the event notification component through the dependency injection container to perform event notification in the target editor.

12. An electronic device, comprising: at least one processor and a memory, wherein
the memory stores computer-executable instructions; and
the at least one processor executes the computer-executable instructions stored in the memory, to cause the at least one processor to:
determine, in response to a trigger instruction for a target editor, an interface interaction component of the target editor and display an editing interface of the target editor based on the interface interaction component, wherein the interface interaction component is configured to indicate an interaction manner for a user to use at least one editing function on a video editing interface, and the interface interaction component is configured to invoke a functional component of the at least one editing function;
invoke, in response to a trigger operation for a target editing function on the target editor, the functional component of the target editing function through the interface interaction component and display an interactive control for the target editing function on the editing interface of the target editor through the functional component of the target editing function, wherein the at least one editing function comprises the target editing function; and
apply, in response to an interactive operation for the interactive control for the target editing function, the target editing function to a material in a video editing draft based on the interactive operation and display a video editing effect.

13. The electronic device according to claim 12, wherein the at least one processor executes the computer-executable instructions stored in the memory, to cause the at least one processor to:
invoke the functional component of the target editing function through the interface interaction component, register the functional component of the target editing function into a dependency injection container, and display the interactive control for the target editing function on the editing interface of the target editor.

14. The electronic device according to claim 13, wherein the at least one processor executes the computer-executable instructions stored in the memory, to cause the at least one processor to:
obtain, in response to the interactive operation for the interactive control for the target editing function, an instance of the functional component of the target editing function from the dependency injection container, and for the material in the video editing draft, run the instance of the functional component of the target editing function to apply the target editing function to the material in the video editing draft and display the video editing effect.

15. The electronic device according to claim 14, wherein the at least one processor executes the computer-executable instructions stored in the memory, to cause the at least one processor to:
register, in response to that the functional component of the target editing function has a dependency relationship with the functional component of an other editing function, the functional component of the other editing function into the dependency injection container.

16. The electronic device according to claim 15, wherein the at least one processor executes the computer-executable instructions stored in the memory, to cause the at least one processor to:
obtain, during a process of running the instance of the functional component of the target editing function, in response to determining that the functional component of the target editing function has the dependency relationship with the functional component of the other editing function, an instance of the functional component of the other editing function from the dependency injection container, and run the instance of the functional component of the other editing function.

17. A non-transitory computer-readable storage medium, wherein the non-transitory computer-readable storage medium stores computer-executable instructions that, when executed by a processor, cause the processor to:
determine, in response to a trigger instruction for a target editor, an interface interaction component of the target editor and display an editing interface of the target editor based on the interface interaction component, wherein the interface interaction component is configured to indicate an interaction manner for a user to use at least one editing function on a video editing interface, and the interface interaction component is configured to invoke a functional component of the at least one editing function;
invoke, in response to a trigger operation for a target editing function on the target editor, the functional component of the target editing function through the interface interaction component and display an interactive control for the target editing function on the editing interface of the target editor through the functional component of the target editing function, wherein the at least one editing function comprises the target editing function; and
apply, in response to an interactive operation for the interactive control for the target editing function, the target editing function to a material in a video editing draft based on the interactive operation and display a video editing effect.

18. The non-transitory computer-readable storage medium according to claim 17, wherein the computer-executable instructions that, when executed by the processor, cause the processor to:
invoke the functional component of the target editing function through the interface interaction component, register the functional component of the target editing function into a dependency injection container, and display the interactive control for the target editing function on the editing interface of the target editor.

19. The non-transitory computer-readable storage medium according to claim 18, wherein the computer-executable instructions that, when executed by the processor, cause the processor to:
obtain, in response to the interactive operation for the interactive control for the target editing function, an instance of the functional component of the target editing function from the dependency injection container, and for the material in the video editing draft, run the instance of the functional component of the target editing function to apply the target editing function to the material in the video editing draft and display the video editing effect.

20. The non-transitory computer-readable storage medium according to claim 19, wherein the computer-executable instructions that, when executed by the processor, cause the processor to:
register, in response to that the functional component of the target editing function has a dependency relationship with the functional component of an other editing function, the functional component of the other editing function into the dependency injection container.
